(19) United States
(12) Patent Application Publication
(10) Pub. No.: US 2023/0177959 A1
(43) Pub. Date: Jun. 8, 2023

(54) VEHICLE ACCIDENT PREDICTION SYSTEM, VEHICLE ACCIDENT PREDICTION METHOD, VEHICLE ACCIDENT PREDICTION PROGRAM, AND LEARNED MODEL CREATION SYSTEM

(71) Applicants: Yazaki Corporation, Tokyo (JP); MITSUI SUMITOMO INSURANCE CO., LTD., Tokyo (JP)

(72) Inventors: Takumi UTSUGI, Tokyo (JP); Hideyuki Zushi, Tokyo (JP); Hajime Shimatani, Tokyo (JP); Yukinobu Mukaida, Tokyo (JP); Junji Tanaka, Shizuoka (JP); Kenichi Hagiya, Tokyo (JP); Yutaka Matsui, Tokyo (JP); Ryosuke Nakahata, Tokyo (JP); Naoya Takahashi, Tokyo (JP); Masaki Kubota, Tokyo (JP)

(73) Assignees: Yazaki Corporation, Tokyo (JP); MITSUI SUMITOMO INSURANCE CO., LTD., Tokyo (JP)

(21) Appl. No.: 18/161,327

(22) Filed: Jan. 30, 2023

Related U.S. Application Data
(63) Continuation of application No. PCT/JP2021/028315, filed on Jul. 30, 2021.

(30) Foreign Application Priority Data
Jul. 31, 2020 (JP) 2020-129797

(51) Int. Cl. G08G 1/16; G06N 3/08

(52) U.S. Cl. CPC G08G 1/16; G06N 3/08

(57) ABSTRACT

A vehicle accident prediction system, a vehicle accident prediction method, a vehicle accident prediction program, and a learned model creation system obtain a training data set containing feature group data, which includes a first feature representing an attribute of a driver of a vehicle, a second feature representing a state of the vehicle, and a third feature combining a plurality of second features, and accident data relating to an accident of the vehicle, create, through learning, a learned model that predicts an accident of the vehicle from the feature group data using a plurality of the obtained training data sets, input the feature group data that is to be a prediction target, and predict an accident of the vehicle from the input feature group data using the created learned model.

### CROSS-REFERENCE TO RELATED APPLICATION

This application is a continuation application of International Application No. PCT/JP2021/028315 filed on Jul. 30, 2021 which claims the benefit of priority from Japanese Patent Application No. 2020-129797 filed on Jul. 31, 2020 and designating the U.S., the entire contents of which are incorporated herein by reference.

### BACKGROUND OF THE INVENTION

### 1. Field of the Invention

The present invention relates to a vehicle accident prediction system, a vehicle accident prediction method, a vehicle accident prediction program, and a learned model creation system.

### 2. Description of the Related Art

As a technique for predicting vehicle accidents, Japanese Patent Application Laid-open No. 2014-35639, for example, discloses a traffic accident occurrence prediction device including an accident occurrence pattern learning means and an accident occurrence prediction means. The accident occurrence pattern learning means learns accident occurrence patterns with predetermined learning algorithms using past traffic data. The accident occurrence prediction means outputs a quantitative tendency of traffic accident occurrence based on actual measured values of traffic data of the current time or predicted values of traffic data after the current time, and the learning results obtained by the accident occurrence pattern learning means.

The traffic accident occurrence prediction device described in Patent Literature 1 described above, however, has room for further improvement in terms of the accuracy of accident prediction, for example.

### SUMMARY OF THE INVENTION

In view of the foregoing, it is an objective of the present invention to provide a vehicle accident prediction system, a vehicle accident prediction method, a vehicle accident prediction program, and a learned model creation system that can properly predict accidents.

In order to achieve the above mentioned object, a vehicle accident prediction system according to one aspect of the present invention includes a preprocessing portion that obtains a training data set containing feature group data including a first feature representing an attribute of a driver of a vehicle, a second feature representing a state of the vehicle, and a third feature combining a plurality of the second features, and accident data relating to an accident of the vehicle; a model creation portion that creates, through learning, a learned model that predicts an accident of the vehicle from the feature group data using a plurality of the training data sets obtained by the preprocessing portion; a prediction target input portion that inputs the feature group data that is to be a prediction target; and a prediction portion that predicts an accident of the vehicle from the feature group data input by the prediction target input portion using the learned model created by the model creation portion.

According to another aspect of the present invention, in the vehicle accident prediction system, it is possible to configure that the first feature includes values quantifying at least one of number of days the driver has been with an operator managing the vehicle, a past traveling distance/time of the driver, on-duty hours of the driver in a predetermined past period, and number of days elapsed since the driver's last service date.

According to still another aspect of the present invention, in the vehicle accident prediction system, it is possible to configure that the third feature includes values quantifying at least one of acceleration distribution in each speed range of the vehicle, deceleration distribution in each speed range of the vehicle, average acceleration and deceleration time in each speed range of the vehicle, direction change amount distribution in each speed range of the vehicle, direction change time in each speed range of the vehicle, distribution of rotation speed of the driving power source in each acceleration range of the vehicle, and direction change amount distribution in each deceleration range of the vehicle.

According to still another aspect of the present invention, in the vehicle accident prediction system, it is possible to configure that the feature group data includes a fourth feature representing a driving scene of the vehicle, and the fourth feature includes values quantifying at least one of a driving scene in a time period when traffic is heavy, a driving scene after a break, a driving scene in which the vehicle is behind a predicted arrival time at a destination, a driving scene in which the vehicle is entering a narrow alley, and a driving scene in rough weather.

In order to achieve the above mentioned object, a vehicle accident prediction method according to another aspect of the present invention includes a step of obtaining a training data set containing feature group data including a first feature representing an attribute of a driver of a vehicle, a second feature representing a state of the vehicle, and a third feature combining a plurality of the second features, and accident data relating to an accident of the vehicle; a step of creating, through learning, a learned model that predicts an accident of the vehicle from the feature group data using a plurality of the obtained training data sets; a step of inputting the feature group data that is to be a prediction target; and a step of predicting an accident of the vehicle from the input feature group data using the created learned model.

In order to achieve the above mentioned object, a vehicle accident prediction program for causing a computer to perform operations according to still another aspect of the present invention includes obtaining a training data set containing feature group data including a first feature representing an attribute of a driver of a vehicle, a second feature representing a state of the vehicle, and a third feature combining a plurality of the second features, and accident data relating to an accident of the vehicle; creating, through learning, a learned model that predicts an accident of the vehicle from the feature group data using a plurality of the obtained training data sets; inputting the feature group data that is to be a prediction target; and predicting an accident of the vehicle from the input feature group data using the created learned model.

In order to achieve the above mentioned object, a learned model creation system according to still another aspect of the present invention includes a preprocessing portion that obtains a training data set containing feature group data including a first feature representing an attribute of a driver of a vehicle, a second feature representing a state of the vehicle, and a third feature combining a plurality of the second features, and accident data relating to an accident of the vehicle; and a model creation portion that creates, through learning, a learned model that predicts an accident of the vehicle from the feature group data using a plurality of the training data sets obtained by the preprocessing portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic configuration of a vehicle accident prediction system according to an embodiment.

FIG. 2 is a schematic view illustrating processes in a learning phase and a use phase performed by a processing circuit of the vehicle accident prediction system according to the embodiment.

FIG. 3 is a flowchart illustrating an example of a process performed by the processing circuit of the vehicle accident prediction system according to the embodiment.

FIG. 4 is a block diagram illustrating a schematic configuration of a vehicle accident prediction system according to a modification.

### DETAILED DESCRIPTION OF THE PREFERRED EMBODIMENTS

The following describes embodiments according to the present invention in detail with reference to the drawings. The present invention is not limited to these embodiments. Additionally, the components of the following embodiments include those that can be easily replaced by those skilled in the art, or those that are substantially the same.

### Embodiments

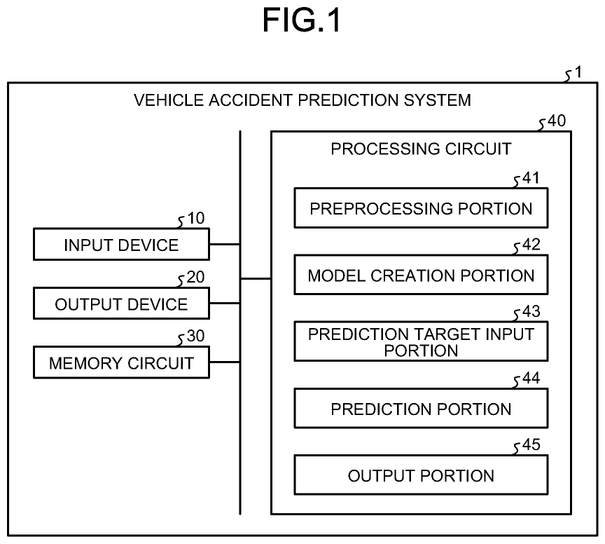

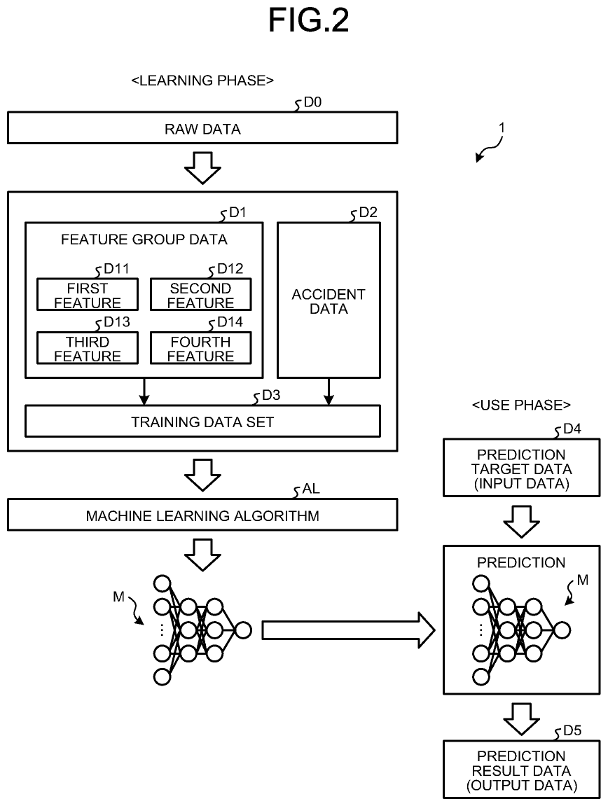

A vehicle accident prediction system 1 of the present embodiment illustrated in FIG. 1 is a system for predicting a vehicle accident. The vehicle accident prediction system 1 has, as illustrated in FIG. 2, a learning phase, in which a process of creating a learned model M for predicting a vehicle accident is performed, and a use phase, in which a process of predicting a vehicle accident using the learned model M is performed. For example, the vehicle accident prediction system 1 is implemented by various computer devices, such as a personal computer, a workstation, a tablet terminal, and the like. Referring to FIGS. 1 and 2, configurations of the vehicle accident prediction system are now described in detail.

Specifically, the vehicle accident prediction system 1 includes an input device 10, an output device 20, a memory circuit 30, and a processing circuit 40. The input device 10, the output device 20, the memory circuit 30, and the processing circuit 40 are connected so as to be able to communicate with one another via a network.

The input device 10 is a device that performs various types of input to the vehicle accident prediction system 1. For example, the input device 10 is implemented by an operation input device that receives various types of operational input from a user, a data input device that receives data (information) input from other devices external to the vehicle accident prediction system 1, and the like. The operation input device is implemented by a mouse, a keyboard, a trackball, a switch, a button, a joystick, a touchpad, a touch screen, a non-contact input circuit, and a voice input circuit, for example. The data input device is implemented by a communication interface that transmits and receives various data to and from devices via wired or wireless communication, a recording media interface that reads various data from recording media such as a flexible disk (FD), a magneto-optical disc, a CD-ROM, a DVD, a USB memory, an SD card memory, and a flash memory, for example.

The output device 20 is a device that performs various types of output from the vehicle accident prediction system 1. For example, the output device 20 is implemented by a display that outputs and displays various types of image information, a speaker that outputs sound information, a data output device that outputs data (information) to other devices external to the vehicle accident prediction system 1, and the like. The data output device is implemented, for example, by a communication interface that transmits and receives various data to and from devices via wired or wireless communication, a recording media interface that writes various data into the same recording media as above, and the like. The data input device and the data output device may share a part or all of the configurations.

The memory circuit 30 is a circuit that stores various data. For example, the memory circuit 30 is implemented by random access memory (RAM), a semiconductor memory element such as a flash memory, a hard disk, an optical disc, and the like. The memory circuit 30 stores computer programs that enable the vehicle accident prediction system 1 to implement various functions, for example. The computer programs stored in the memory circuit 30 include a computer program for causing the input device 10 to function, a computer program for causing the output device 20 to function, a computer program for causing the processing circuit 40 to function, and the like. Also, the memory circuit 30 stores various data, such as raw data DO input via the input device 10, data necessary for various processes of the processing circuit 40, a training data set D3 used for the learning of a learned model M, a learned model M, and prediction result data D5 to be output via the output device 20. The processing circuit 40 or the like reads out these various data from the memory circuit 30 as needed. The memory circuit 30 may also be implemented by a cloud server or the like that is connected to the vehicle accident prediction system 1 via a network.

The processing circuit 40 is a circuit that implements various processing functions of the vehicle accident prediction system 1. For example, the processing circuit 40 is implemented by a processor. The processor refers to, for example, a circuit such as a central processing unit (CPU), a micro processing unit (MPU), an application specific integrated circuit (ASIC), a field programmable gate array (FPGA), and the like. The processing circuit 40 implements the processing functions by executing computer programs read from the memory circuit 30, for example.

An outline of the overall configuration of the vehicle accident prediction system 1 according to the present embodiment is described above. Under this configuration, the processing circuit 40 according to the present embodiment has a function of performing various processes to create a learned model M for predicting a vehicle accident in the learning phase. Furthermore, the processing circuit 40 according to the present embodiment has a function of performing various processes to predict a vehicle accident using the learned model M in the use phase.

To implement the various processing functions described above, the processing circuit 40 of the present embodiment functionally and conceptually includes a preprocessing portion 41, a model creation portion 42, a prediction target input portion 43, a prediction portion 44, and an output portion 45. For example, the processing circuit 40 executes a computer program read from the memory circuit 30 to implement the processing functions of the preprocessing portion 41, the model creation portion 42, the prediction target input portion 43, the prediction portion 44, and the output portion 45.

The preprocessing portion 41 is a part that has a function capable of performing various preprocessing operations on data for training a learned model M in the learning phase. The preprocessing portion 41 of the present embodiment can perform a process of obtaining a training data set D3 containing feature group data D1 and accident data D2.

The training data set D3 obtained by the preprocessing portion 41 is teaching data used to create a learned model M through machine learning. The training data set D3 is formed by associating the feature group data D1, which relates to the traveling of a vehicle, with the accident data D2, which relates to an accident of the vehicle in a vehicle traveling state defined by the feature group data D1, as one set. Specifically, the training data set D3 contains the feature group data D1 quantified as explanatory variables and the accident data D2 quantified as objective variables.

Typically, feature group data D1 is data that includes various features relating to the traveling of a vehicle. The feature group data D1 of the present embodiment is data that includes a first feature D11, a second feature D12, a third feature D13, and a fourth feature D14. The first feature D11, the second feature D12, the third feature D13, and the fourth feature D14 are features that affect the occurrence of a vehicle accident and are correlated in terms of the occurrence of a vehicle accident. For example, the first feature D11, the second feature D12, the third feature D13, and the fourth feature D14 are set as features that correlate with the risk of accident occurrence based on findings obtained by analyzing data of a large number of vehicle accidents. Examples of the first feature D11, the second feature D12, the third feature D13, and the fourth feature D14 are described below.

The first feature D11 is a “driver attribute feature” that represents an attribute of a driver of a vehicle and is a value quantifying the attribute of the driver of the vehicle. The first feature D11 may include, for example, a value quantifying the driver's attendance information and the like. In one example, the first feature D11 includes values quantifying the number of days the driver has been with an operator managing the vehicle, a past traveling distance/time of the driver, on-duty hours of the driver in a predetermined past period, the number of days elapsed since the driver's last service date, and the like. The first feature D11 is set, for example, based on the findings that the attribute of the vehicle driver (e.g., most recent attendance status) affects the occurrence of a vehicle accident.

The second feature D12 is a “vehicle state feature” that represents a state of the vehicle and is a value quantifying the vehicle state. The second feature D12 may include, for example, a value quantifying a detection result detected in the vehicle by various on-board devices, sensors, cameras, position measuring instruments, and the like mounted on the vehicle. Typically, the second feature D12 is obtained by treating each of the above detection results as independent data. In one example, the second feature D12 includes values quantifying a vehicle speed (maximum, minimum, average, variance), vehicle acceleration, vehicle deceleration, a rotation speed of a vehicle driving power source, a vehicle direction change amount, and the like. The second feature D12 is set, for example, based on the findings that the state of the vehicle affects the occurrence of a vehicle accident.

The third feature D13 is a “combination feature” that combines a plurality of the second features D12, and is a value quantifying the combination of the second features D12. The third feature D13 may include, for example, a value quantifying a combination of a plurality of detection results detected in the vehicle by various on-board devices, sensors, cameras, position measuring instruments, and the like mounted on the vehicle. Typically, the third feature D13 is obtained by combining a plurality of the second features D12, each obtained by treating each of the above detection results as independent data, so that they represent a specific traveling phase and are treated as composite data. In one example, the third feature D13 includes, for example, values quantifying acceleration distribution in each speed range, deceleration distribution in each speed range, average acceleration and deceleration time in each speed range, direction change amount distribution in each speed range, direction change time in each speed range, distribution of rotation speed of the driving power source in each acceleration range, direction change amount distribution in each deceleration range, and the like. The third feature D13 is set, for example, based on the findings that even when primary second features D12 (e.g., acceleration) are equivalent, different secondary second features D12 (e.g., speed range) may result in different occurrence rates of vehicle accident.

The fourth feature D14 is a “scene feature” that represents a driving scene of the vehicle and is a value quantifying the driving scene of the vehicle. The fourth feature D14 may include, for example, values quantifying various driving scenes based on an external environment surrounding the vehicle, climate, terrain, a psychological state of the driver during traveling of the vehicle, and the like. For example, the fourth feature D14 may be quantified using detection results detected by various on-board devices, sensors, cameras, position measuring instruments, and the like mounted on the vehicle, or may be quantified using other values. In one example, the fourth feature D14 includes a value quantifying a driving scene in a time period when traffic is heavy, a driving scene after a break, a driving scene in which the vehicle is behind a predicted arrival time at a destination, a driving scene in which the vehicle is entering a narrow alley, a driving scene in rough weather, and the like. The fourth feature D14 is set, for example, based on the findings that even when the first features D11, the second features D12, and the third features D13 are equivalent, different driving scenes may result in different occurrence rates of vehicle accident.

The accident data D2 is data relating to a vehicle accident. The accident data D2 includes information on an accident of a vehicle in the traveling state of the vehicle defined by the associated feature group data D1. In one example, the accident data D2 includes at least information indicating the presence or absence of the occurrence of an accident and may also include information indicating the accident location (latitude and longitude), accident cause, accident type, amount of damage, and the like.

The preprocessing portion 41 obtains a training data set D3 that is formed by associating the above feature group data D1 with the above accident data D2 corresponding to this feature group data D1 as one set. The preprocessing portion 41 may, for example, directly obtain a training data set D3 that is created in advance from another device external to the vehicle accident prediction system 1 via a data input device forming the input device 10. The preprocessing portion 41 may also create and obtain a training data set D3 by performing various preprocessing operations on the raw data DO input from another device external to the vehicle accident prediction system 1, for example. The preprocessing portion 41 may, for example, perform preprocessing on the raw data DO each time the raw data DO is input, or it may perform preprocessing on the raw data DO at a suitable time in response to a user operation via an operation input device forming the input device 10.

In this case, the raw data DO to be preprocessed by the preprocessing portion 41 may be input from another device external to the vehicle accident prediction system 1 via a data input device forming the input device 10, or may be input by a user operation via an operation input device forming the input device 10. Such raw data DO may include, for example, on-board system data, operator data, accident statistics data, external data, and the like. The on-board system data is, for example, vehicle signals of the vehicle and data detected by on-board devices, such as a drive recorder and a digital tachograph, sensors, cameras, position measuring instruments, and the like mounted on the vehicle, and may include information such as a vehicle speed (maximum, minimum, average, variance), vehicle acceleration, vehicle deceleration, a rotation speed of a vehicle driving power source, a vehicle direction change amount, and the like. The operator data is, for example, data held by an operator, such as a transport company or bus company, and may include information such as an operator ID, a vehicle ID, a driver ID, attendance, vehicle interior and exterior videos, driver's vital signs, and the like. The accident statistics data is, for example, data held by a damage insurance company, and may include information such as an accident occurrence operator ID, an accident occurrence vehicle ID, date and time of an accident, the latitude and longitude of accident occurrence, an accident type, the amount of damage, and the like. The external data is, for example, be data held by other external devices or databases, and may include information such as maps (road type, building/facility type), traffic congestion, weather, human flow distribution/population density, and the like.

The preprocessing performed by the preprocessing portion 41 on raw data DO includes a process of collecting and combining the raw data DO, a process of extracting feature group data D1, such as a first feature D11, a second feature D12, a third feature D13, and a fourth feature D14, from the raw data DO and quantifying them as explanatory variables, a process of extracting accident data D2 from the raw data DO and quantifying it as objective variables, and a process of associating the quantified feature group data D1 with the quantified accident data D2 and combining them together.

The preprocessing portion 41 stores a plurality of the training data sets D3 obtained as described above in the memory circuit 30.

The model creation portion 42 is a part that has a function capable of performing the process of creating a learned model M that predicts a vehicle accident from feature group data D1 through machine learning in the learning phase. The model creation portion 42 of the present embodiment can perform the process of creating a learned model M through machine learning using a plurality of training data sets D3 obtained by the preprocessing portion 41. For example, the model creation portion 42 performs a process of training and creating a learned model M at a suitable time in response to a user operation via an operation input device forming the input device 10.

The model creation portion 42 creates a learned model M by performing machine learning based on various machine learning algorithms AL using a plurality of training data sets D3 as teaching data. The machine learning algorithms AL used include, for example, known algorithms such as deep learning, neural network, logistic regression, ensemble learning, support vector machine, random forest, naive Bayes, and the like. The model creation portion 42 performs machine learning of a learned model M using, of the training data sets D3, the feature group data D1 as explanatory variables and the accident data D2 as objective variables. As a result of this machine learning, the model creation portion 42 creates a learned model M that is trained through machine learning to predict a vehicle accident from feature group data D1.

The learned model M is implemented by a neural network, for example. In this case, the model creation portion 42 performs machine learning using a plurality of training data sets D3 to learn learning weighting factors used as weights in the neural network, and creates the learned model M.

The learned model M created by the model creation portion 42 takes feature group data D1 as input and outputs a value quantifying a vehicle accident prediction. That is, the learned model M is configured to function to receive input of feature group data D1 and output a value quantifying a vehicle accident prediction based on this feature group data D1. More specifically, the learned model M causes a computer to function to perform operations based on the learning weighting factors of the neural network on the feature group data D1 input to the input layer of the neural network, and output from the output layer of the neural network a value quantifying an accident prediction.

In other words, the value quantifying a vehicle accident prediction output from the learned model M corresponds to a predicted value of an accident risk of the vehicle. The value quantifying a vehicle accident prediction is a value quantifying the presence or absence of the occurrence of an accident in one example, but may be a value quantifying an accident cause, accident type, or the amount of damage, for example.

The model creation portion 42 stores the learned model M created as described above in the memory circuit 30. When a learned model M that is previously created is already stored in the memory circuit 30, the model creation portion 42 replaces the stored learned model M with the newly created learned model M.

The prediction target input portion 43 is a part that has a function capable of performing a process of inputting feature group data D1 that is to be a prediction target in the use phase. Here, the feature group data D1 that is to be the prediction target may also be referred to as “prediction target data (input data) D4”. The prediction target data D4 may be input from another device external to the vehicle accident prediction system 1 via a data input device forming the input device 10, or may be input by a user operation via an operation input device forming the input device 10. The prediction target input portion 43 of the present embodiment is capable of performing a process of inputting the prediction target data D4 received via the input device 10 to the prediction portion 44. For example, the prediction target input portion 43 may input the prediction target data D4 in real time as the vehicle travels, or perform ex-post input of the prediction target data D4 at a suitable time after the traveling of the vehicle ends. The prediction target input portion 43 may temporarily store, in the memory circuit 30, the prediction target data D4 to be input.

The prediction portion 44 is a part that has a function capable of performing the process of predicting a vehicle accident using the learned model M in the use phase. The prediction portion 44 of the present embodiment is capable of performing the process of predicting a vehicle accident from the prediction target data D4, that is, the feature group data D1 that is to be the prediction target and input by the prediction target input portion 43, using the learned model M created by the model creation portion 42.

The prediction portion 44 inputs, as input data, the prediction target data D4 input by the prediction target input portion 43 into the learned model M created by the model creation portion 42, and causes the learned model M to output a value quantifying a vehicle accident prediction accordingly. Thus, the prediction portion 44 predicts an accident of the vehicle in the vehicle traveling state defined by the prediction target data D4 (the feature group data D1 that is to be the prediction target). Here, as an example, the prediction portion 44 outputs a value quantifying the presence or absence of the occurrence of a vehicle accident as described above as a value quantifying a vehicle accident prediction, and thus predicts the presence or absence of the occurrence of an accident of the vehicle. The prediction portion 44 stores the output value quantifying a vehicle accident prediction in the memory circuit 30 as prediction result data (output data) D5.

The output portion 45 is a part that has a function capable of performing a process of outputting based on the vehicle accident prediction result obtained from the prediction portion 44. The output portion 45 of the present embodiment is capable of performing a process of outputting the prediction result data D5 predicted by the prediction portion 44 via the output device 20. The prediction result data D5 may be output as image information via a display forming the output device 20, or may be output as sound information via a speaker forming the output device 20. Also, the prediction result data D5 may be output to another device external to the vehicle accident prediction system 1 via a data output device forming the output device 20. The output portion 45 may, for example, output the prediction result data D5 in real time as the vehicle travels, or it may output the prediction result data D5 at a suitable time in response to a user operation via an operation input device forming the input device 10.

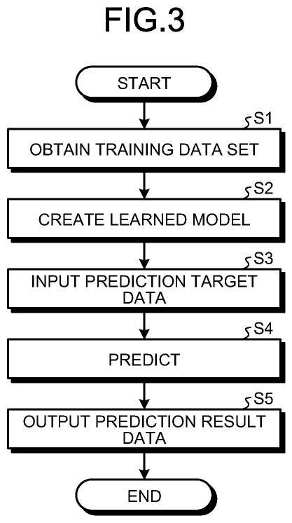

Referring to the flowchart diagram of FIG. 3, a process procedure of a vehicle accident prediction method of the vehicle accident prediction system 1 is now described.

The vehicle accident prediction method of the vehicle accident prediction system 1 illustrated in FIG. 3 includes an obtainment step (step S1), a creation step (step S2), an input step (step S3), a prediction step (step S4), and an output step (step S5). Here, the operations of these steps are performed by the processing circuit 40 of the vehicle accident prediction system 1.

First, the preprocessing portion 41 of the processing circuit 40 performs the step (step S1) of obtaining a training data set D3 containing feature group data D1, which includes a first feature D11, a second feature D12, a third feature D13, and a fourth feature D14, and accident data D2. In this case, the preprocessing portion 41 may directly obtain a training data set D3 from another device external to the vehicle accident prediction system 1 via the input device 10, or may create and obtain a training data set D3 by performing various preprocessing operations on raw data DO input from another device external to the vehicle accident prediction system 1 via the input device 10. The preprocessing portion 41 stores a plurality of the obtained training data sets D3 in the memory circuit 30.

Next, the model creation portion 42 of the processing circuit 40 performs the creation step (step S2) of creating a learned model M through machine learning using the training data sets D3 obtained at the obtainment step (step S1). The model creation portion 42 stores the created learned model M in the memory circuit 30. When a learned model M that is previously created is already stored in the memory circuit 30, the model creation portion 42 replaces the stored learned model M with the newly created learned model M.

Then, the prediction target input portion 43 of the processing circuit 40 performs the input step (step S3) of inputting prediction target data D4, which is feature group data D1 that is to be a prediction target, to the prediction portion 44 of the processing circuit 40. In this case, the prediction target input portion 43 may input prediction target data D4 received from another device external to the vehicle accident prediction system 1 via the input device 10, or input prediction target data D4 received by a user operation via the input device 10. The prediction target input portion 43 may also temporarily store, in the memory circuit 30, the prediction target data D4 to be input.

The prediction portion 44 of the processing circuit 40 then performs the prediction step (step S4) of predicting a vehicle accident from the prediction target data D4 (feature group data D1 that is to be the prediction target) input at the input step (step S3) using the learned model M created at the creation step (step S2). In this case, the prediction portion 44 inputs the prediction target data D4 to the learned model M and causes the learned model M to output a value quantifying a vehicle accident prediction. In this manner, the prediction portion 44 predicts an accident of the vehicle in the vehicle traveling state defined by the prediction target data D4. The prediction portion 44 stores the output value quantifying a vehicle accident prediction in the memory circuit 30 as prediction result data D5.

Then, the output portion 45 of the processing circuit 40 performs the output step (step S5) of outputting the prediction result data D5 of a vehicle accident predicted at the prediction step (step S4), and ends the process of this flowchart. In this case, the output portion 45 may output the prediction result data D5 as image information or sound information via the output device 20, or output to another device external to the vehicle accident prediction system 1 via the output device 20.

The vehicle accident prediction method described above can be implemented by executing a pre-prepared vehicle accident prediction program on a computer such as a personal computer or a workstation. This vehicle accident prediction program causes the computer to perform the operation of each of the obtainment step (step S1), the creation step (step S2), the input step (step S3), the prediction step (step S4), and the output step (step S5) described above.

The vehicle accident prediction system 1, the vehicle accident prediction method, and the vehicle accident prediction program described above can create a learned model M with high prediction accuracy, and predict a vehicle accident using not only a second feature D12, which represents a vehicle state, but also a first feature D11, which represents an attribute of the vehicle driver, a third feature D13, which is a combination of a plurality of second features D12, and the like to refine the input features themselves. As a result, the vehicle accident prediction system 1, the vehicle accident prediction method, and the vehicle accident prediction program can properly predict an accident. Thus, the vehicle accident prediction system 1, the vehicle accident prediction method, and the vehicle accident prediction program can predict an accident risk more precisely, for example.

Here, the vehicle accident prediction system 1, the vehicle accident prediction method, and the vehicle accident prediction program described above can create a learned model M and predict a vehicle accident based on a fourth feature D14, which represents a vehicle driving scene, as well as a first feature D11, a second feature D12, and a third feature D13. This allows for accident prediction with higher dimensionality based on the driving scene.

The vehicle accident prediction system 1, the vehicle accident prediction method, and the vehicle accident prediction program can then provide the operator or the driver with the accident prediction result that is obtained as described and has higher accuracy, for various purposes such as real-time driving warnings, evaluation of driving techniques, driving habits, and accident risks, visualization of areas for improvement, guidance and education on accident risk control behavior, and creation of safe service plans. The vehicle accident prediction system 1, the vehicle accident prediction method, and the vehicle accident prediction program can also output the accident prediction result for each service, driver, vehicle, and operator.

In the embodiment described above, an example of the vehicle accident prediction system 1 is described in which a single system performs both the learning phase and the use phase, but embodiments are not limited to this.

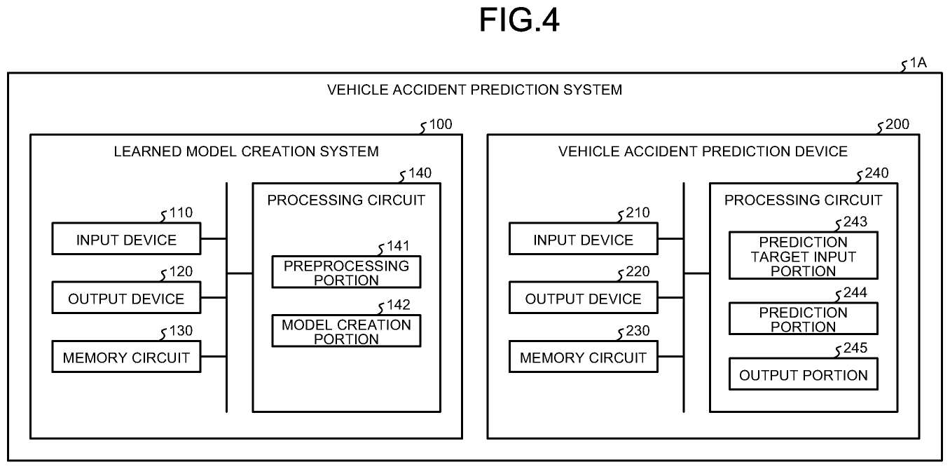

For example, a vehicle accident prediction system 1A according to a modification illustrated in FIG. 4 differs from the vehicle accident prediction system 1 described above in that it has a configuration in which a learned model creation system 100, which performs the processes in the learning phase, is separate from a vehicle accident prediction device 200, which performs the processes in the use phase.

The learned model creation system 100 includes an input device 110, an output device 120, a memory circuit 130, and a processing circuit 140, and performs the process of creating a learned model M through machine learning using training data sets D3. To implement the various processing functions described above, the processing circuit 140 functionally and conceptually includes a preprocessing portion 141 and a model creation portion 142.

In the same manner as the preprocessing portion 41 described above, the preprocessing portion 141 can perform the process of obtaining a training data set D3 containing feature group data D1, which includes a first feature D11, a second feature D12, a third feature D13, and a fourth feature D14, and accident data D2. The preprocessing portion 141 stores a plurality of the obtained training data sets D3 in the memory circuit 130.

In the same manner as the model creation portion 42 described above, the model creation portion 142 can perform the process of creating a learned model M through machine learning using the training data sets D3 obtained by the preprocessing portion 141. The model creation portion 142 stores the created learned model M in the memory circuit 130.

The vehicle accident prediction device 200 has an input device 210, an output device 220, a memory circuit 230, and a processing circuit 240, and performs the process of predicting a vehicle accident using the learned model M. To implement the various processing functions described above, the processing circuit 240 functionally and conceptually includes a prediction target input portion 243, a prediction portion 244, and an output portion 245.

In the same manner as the prediction target input portion 43 described above, the prediction target input portion 243 can perform the process of inputting prediction target data D4, which is the feature group data D1 that is to be the prediction target.

In the same manner as the prediction portion 44 described above, the prediction portion 244 can perform the process of predicting a vehicle accident from the prediction target data D4 input by the prediction target input portion 243 using the learned model M. In this case, the prediction portion 244 can use, for example, a learned model M that is stored in the memory circuit 230 in advance via the output device 120 of the learned model creation system 100 and the input device 210 of the vehicle accident prediction device 200. This learned model M is a model created by the learned model creation system 100 as described above.

In the same manner as the output portion 45 described above, the output portion 245 can perform the process of outputting prediction result data D5 predicted by the prediction portion 44 via the output device 220.

Other configurations of the input devices 110 and 210, the output devices 120 and 220, the memory circuits 130 and 230, and the processing circuits 140 and 240 are substantially the same as those of the input device 10, the output device 20, the memory circuit 30, and the processing circuit 40 described above.

In this case, the vehicle accident prediction system 1A, the learned model creation system 100, and the vehicle accident prediction device 200 can also properly predict an accident in the same manner as the vehicle accident prediction system 1 described above, and can predict an accident risk more precisely, for example.

In this modification, the learned model M used by the vehicle accident prediction device 200 is not limited to the model created by the learned model creation system 100 as described above, and may be a learned model M created by other systems.

The vehicle accident prediction system, the vehicle accident prediction method, the vehicle accident prediction program, and the learned model creation system according to the embodiments of the present invention described above are not limited to the embodiments described above, and various modifications are possible within the scope of the claims.

In the above explanation, feature group data D1 is described as data including a first feature D11, a second feature D12, a third feature D13, and a fourth feature D14, but is not limited to this. For example, feature group data D1 may include a first feature D11 and a second feature D12 but not a third feature D13 or a fourth feature D14, may include a first feature D11 and a third feature D13 but not a second feature D12 or a fourth feature D14, may include a first feature D11 and a fourth feature D14 but not a second feature D12 or a third feature D13, or may include any other combination.

The processing circuit 40 described above is described as implementing the processing functions using a single processor, but it is not limited to this. The processing circuit 40 may implement the processing functions by combining a plurality of independent processors and executing computer programs using these processors. The processing functions of the processing circuit 40 may be distributed or integrated into a single or a plurality of processing circuits as appropriate. The processing functions of the processing circuit 40 may be implemented in whole or in any part by a computer program, or may be implemented as hardware using wired logic or the like.

The computer program to be executed by the processor described above is incorporated in advance in the memory circuit 30 or the like to be provided. The computer program may be provided as a file in a format that can be installed or executed on these devices and recorded on a computer-readable storage medium. The computer program may also be stored in a computer connected to a network such as the Internet and downloaded via the network to be provided or distributed.

The vehicle accident prediction system, the vehicle accident prediction method, the vehicle accident prediction program, and the learned model creation system according to the present embodiment may be configured by combining components of the embodiments and modifications described above as appropriate.

The vehicle accident prediction system, the vehicle accident prediction method, the vehicle accident prediction program, and the learned model creation system according to the present embodiment have an advantageous effect of properly predicting accidents.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle accident prediction system comprising:
a preprocessing portion that obtains a training data set containing feature group data including a first feature representing an attribute of a driver of a vehicle, a second feature representing a state of the vehicle, and a third feature combining a plurality of the second features, and accident data relating to an accident of the vehicle;
a model creation portion that creates, through learning, a learned model that predicts an accident of the vehicle from the feature group data using a plurality of the training data sets obtained by the preprocessing portion;
a prediction target input portion that inputs the feature group data that is to be a prediction target; and
a prediction portion that predicts an accident of the vehicle from the feature group data input by the prediction target input portion using the learned model created by the model creation portion.

2. The vehicle accident prediction system according to claim 1, wherein
the first feature includes values quantifying at least one of number of days the driver has been with an operator managing the vehicle, a past traveling distance/time of the driver, on-duty hours of the driver in a predetermined past period, and number of days elapsed since the driver's last service date.

3. The vehicle accident prediction system according to claim 1, wherein
the third feature includes values quantifying at least one of acceleration distribution in each speed range of the vehicle, deceleration distribution in each speed range of the vehicle, average acceleration and deceleration time in each speed range of the vehicle, direction change amount distribution in each speed range of the vehicle, direction change time in each speed range of the vehicle, distribution of rotation speed of the driving power source in each acceleration range of the vehicle, and direction change amount distribution in each deceleration range of the vehicle.

4. The vehicle accident prediction system according to claim 2, wherein
the third feature includes values quantifying at least one of acceleration distribution in each speed range of the vehicle, deceleration distribution in each speed range of the vehicle, average acceleration and deceleration time in each speed range of the vehicle, direction change amount distribution in each speed range of the vehicle, direction change time in each speed range of the vehicle, distribution of rotation speed of the driving power source in each acceleration range of the vehicle, and direction change amount distribution in each deceleration range of the vehicle.

5. The vehicle accident prediction system according to claim 1, wherein
the feature group data includes a fourth feature representing a driving scene of the vehicle, and
the fourth feature includes values quantifying at least one of a driving scene in a time period when traffic is heavy, a driving scene after a break, a driving scene in which the vehicle is behind a predicted arrival time at a destination, a driving scene in which the vehicle is entering a narrow alley, and a driving scene in rough weather.

6. The vehicle accident prediction system according to claim 2, wherein
the feature group data includes a fourth feature representing a driving scene of the vehicle, and
the fourth feature includes values quantifying at least one of a driving scene in a time period when traffic is heavy, a driving scene after a break, a driving scene in which the vehicle is behind a predicted arrival time at a destination, a driving scene in which the vehicle is entering a narrow alley, and a driving scene in rough weather.

7. The vehicle accident prediction system according to claim 3, wherein
the feature group data includes a fourth feature representing a driving scene of the vehicle, and
the fourth feature includes values quantifying at least one of a driving scene in a time period when traffic is heavy, a driving scene after a break, a driving scene in which the vehicle is behind a predicted arrival time at a destination, a driving scene in which the vehicle is entering a narrow alley, and a driving scene in rough weather.

8. The vehicle accident prediction system according to claim 4, wherein
the feature group data includes a fourth feature representing a driving scene of the vehicle, and
the fourth feature includes values quantifying at least one of a driving scene in a time period when traffic is heavy, a driving scene after a break, a driving scene in which the vehicle is behind a predicted arrival time at a destination, a driving scene in which the vehicle is entering a narrow alley, and a driving scene in rough weather.

9. A vehicle accident prediction method comprising:
a step of obtaining a training data set containing feature group data including a first feature representing an attribute of a driver of a vehicle, a second feature representing a state of the vehicle, and a third feature combining a plurality of the second features, and accident data relating to an accident of the vehicle;
a step of creating, through learning, a learned model that predicts an accident of the vehicle from the feature group data using a plurality of the obtained training data sets;
a step of inputting the feature group data that is to be a prediction target; and
a step of predicting an accident of the vehicle from the input feature group data using the created learned model.

10. A vehicle accident prediction program for causing a computer to perform operations comprising:
obtaining a training data set containing feature group data including a first feature representing an attribute of a driver of a vehicle, a second feature representing a state of the vehicle, and a third feature combining a plurality of the second features, and accident data relating to an accident of the vehicle;
creating, through learning, a learned model that predicts an accident of the vehicle from the feature group data using a plurality of the obtained training data sets;
inputting the feature group data that is to be a prediction target; and
predicting an accident of the vehicle from the input feature group data using the created learned model.

11. A learned model creation system comprising:
a preprocessing portion that obtains a training data set containing feature group data including a first feature representing an attribute of a driver of a vehicle, a second feature representing a state of the vehicle, and a third feature combining a plurality of the second features, and accident data relating to an accident of the vehicle; and
a model creation portion that creates, through learning, a learned model that predicts an accident of the vehicle from the feature group data using a plurality of the training data sets obtained by the preprocessing portion.
